(19) United States
(12) Patent Application Publication
(10) Pub. No.: US 2014/0326044 A1
(43) Pub. Date: Nov. 6, 2014

(54) Gas Detection Pre-treatment Device

(71) Applicant: Weidong Yan, Cheung Sha Wan (CN)

(72) Inventor: Weidong Yan, Cheung Sha Wan (CN)

(21) Appl. No.: 13/886,303

(22) Filed: May 3, 2013

(51) Int. Cl. G01N 30/06

(52) U.S. Cl. CPC G01N 30/06
USPC 73/23.41

(57) ABSTRACT

A gas detection pre-treatment device contains an inert gas cylinder, a standard gas cylinder, an untested gas cylinder, a separating unit, a first connecting tube, a cooling unit, and an interface unit. Each of the inert gas cylinder, the standard gas cylinder, and the untested gas cylinder has an outlet pipe connecting with the first connecting tube. The first connecting pipe couples with the separating unit, and the separating unit includes a controlling channel and a separation chamber. The control channel has a first control vale, a second control valve, and a third control valve. Inlet ends of the first control valve and the second control valve couple with the first connecting pipe, an outlet end of the second control valve connects with the interface unit, an outlet end of the third control valve connects with the interface unit, and the separation chamber is covered in the cooling unit.

### FIELD OF THE INVENTION

The present invention relates to a gas separating device and a method of separating gases, and more particularly to a gas detection pre-treatment device and a method of testing gases.

### BACKGROUND OF THE INVENTION

Electronic industrial gases (such as siH₄, GeH₄) are widely used in manufacturing process of electronic elements, because they have lower impurities. However, the electronic industrial gases have poor chemical properties, such as flammable, explosive and toxic, hence a testing difficulty of purity of the electronic industrial gases increases.

According to a Standard of Electronic Industrial Gases, impurity gases contains CO, CO₂, H₂, O₂, N₂, H₂O, hydrocarbons (C₁ to C₃) and chlorides, wherein a testing method of a thermal conductivity detector or a helium ionization detector is set in this Standard, but some problems, such as main compositions covers or interferes trace impurity composition, pollution to a detector, or damage to worker, are not regulated in the Standard. In recent years, Chromatographic Analysis Technologies, Inc. (such as America GOW MAC, UK SERIES, Ireland AGC, China Huaai, Kechuang) develops and researches chromatography instruments for electronic industrial gases so as to improve and automate chromatographic sampling system, thus increasing testing accuracy. However, such chromatography instruments are expensive.

The present invention has arisen to mitigate and/or obviate the afore-described disadvantages.

### SUMMARY OF THE INVENTION

The primary object of the present invention is to provide a gas detection pre-treatment device and a method of testing gases which are capable of enhancing testing safety and reliability.

To obtain the above objective, a gas detection pre-treatment device provided by the present invention contains: an inert gas cylinder, a standard gas cylinder, an untested gas cylinder, a separating unit, a first connecting tube, a cooling unit, and an interface unit.

Each of the inert gas cylinder, the standard gas cylinder, and the untested gas cylinder has an outlet pipe connecting with the first connecting tube, the first connecting pipe couples with the separating unit, and the separating unit includes a controlling channel and a separation chamber, the control channel has a first control vale, a second control valve, and a third control valve, wherein an inlet end of the first control valve connects with the first connecting pipe, and an inlet end of the second control valve couples with the first connecting pipe, an outlet end of the second control valve is in connection with the interface unit.

Also, an outlet end of the third control valve connects with the interface unit, the first control valve is fixed between the first connecting pipe and the separation chamber, the second control valve is mounted between the first connecting pipe and the interface unit, and the third control valve is mounted between the separation chamber and the interface unit, the separation chamber is covered in the cooling unit.

Also, a gas detection pre-treatment device provided by the present invention contains:

A method of testing gases of a gas detection pre-treatment device contains:

(1) holding inert gas, standard gas, and untested gas into inert a gas cylinder, a standard gas cylinder, and a untested gas cylinder;

(2) blowing the inert gas in the inert gas cylinder toward a pipeline;

(3) blowing the standard gas in the standard gas cylinder toward the pipeline, turning off a first control valve and a third control valve, sealing and cooling the standard gas in the separation chamber at a certain amount within a period of time so as to separate the standard gas;

(4) blowing a part of separated standard gas into an interface unit by means of the inert gas in the inert gas cylinder so as to analyze the part of separated standard gas by using the gas chromatograph;

(5) blowing the inert gas in the inert gas cylinder toward the pipeline;

(6) blowing the untested gas in the untested gas cylinder toward the pipeline, turning off the first control valve and the third control valve, sealing and cooling the untested gas in the separation chamber at a certain amount within a period of time so as to separate the untested gas;

(7) blowing a part of separated untested gas into the interface unit by means of the inert gas in the inert gas cylinder so as to analyze the part of separated untested gas by ways of the gas chromatograph;

(8) marking content of impurities of the mixed gas by using the standard gas.

In addition, a method of testing gases contains: separating gas into a first part and a second part by using cryogenic distillation, wherein a boiling point of the second part is less than a boiling point of the first part; and the second part is guided into gas chromatograph to be analyzed by using inert gas.

Thereby, the cryogenic distillation technology is applied in a pre-test process for a purity test of flammable, explosive, toxic, industrial gas so as to prevent flammable, explosive, and toxic gases (such as SiH4, GeH4) from polluting and damaging the gas chromatograph. In addition, dangerous main compositions in the electronic industrial gases are filtered, and chromatogram of impurities of the electronic industrial gases are analyzed so as to test purity of flammable, explosive and toxic electronics industrial gases quickly and safely at low cost.

Furthermore, the gas detection pre-treatment device is used to cryogenically distill mixed gas, and main compositions of the mixed gases with a high boiling point (such as SiH4, GeH4) are filtered so that the main compositions of the mixed gases with the high boiling point do not flow into the gas chromatograph, thus preventing the gas chromatograph from being polluted. Besides, toxic gas is discharged out of the plurality of exits 8 of the front end and the distal end of the pipeline, thus preventing worker from being damaged by flammable, explosive, toxic, chemically active electronic industrial gas. Also, the SiH4 and/or GeH4 is filtered by the gas detection pre-treatment device so that back flushing path is omitted to lower production costs of the gas chromatograph and the gas detection pre-treatment device.

### BRIEF DESCRIPTION OF THE DRAWINGS

FIG. 1 is a diagram of a gas detection pre-treatment device according to the present invention.

FIG. 2 is a diagram of a spectrum of standard gas tested by using conventional gas testing method.

FIG. 3 is a diagram of a test report of the standard gas tested by using conventional gas testing method.

FIG. 4 is a diagram of a spectrum of a Silane sample tested by using conventional gas testing method.

FIG. 5 is a diagram of a test report of the Silane sample tested by using conventional gas testing method.

FIG. 6 is a diagram of a spectrum of standard gas tested by using a method of testing gases according to the present invention.

FIG. 7 is a diagram of a test report of the standard gas tested by using the method of testing gases according to the present invention.

FIG. 8 is a diagram of a spectrum of a Silane sample tested by using a method of testing gases according to the present invention.

FIG. 9 is a diagram of a test report of the Silane sample tested by using the method of testing gases according to the present invention.

### DETAILED DESCRIPTION OF THE PREFERRED EMBODIMENTS

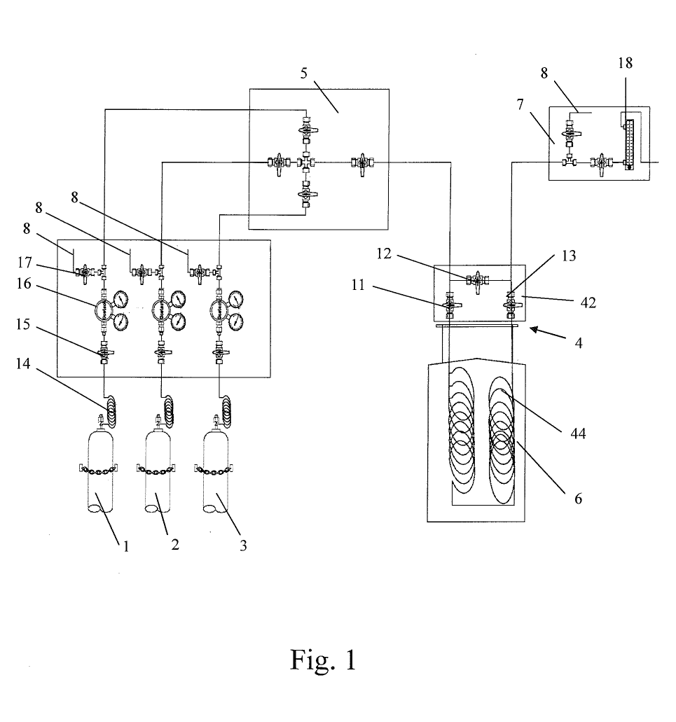

With reference to FIG. 1, a gas detection pre-treatment device according to a preferred embodiment of the present invention is used to analyze chromatogram of mixed gases, and the mixed gases are comprised of electronic industrial gas, such as Silane (SiH4) or

Germane (GeH₄), wherein trace gases of the Silane (SiH4) or Germane (GeH₄) include H2, N2, CO, O₂, CH₄, Oxide, CO₂, and Propane. Main compositions and partial compositions of the mixed gases are separated by using cryogenic distillation technology so as to test content of the trace gases.

The gas detection pre-treatment device contains an inert gas cylinder 1, a standard gas cylinder 2, an untested gas cylinder 3, a separating unit 4, a first connecting tube 6, a cooling unit 6, and an interface unit 7.

The inert gas cylinder 1 is used to receive purity helium gases, the standard gas cylinder 2 is applied to receive standard gases, and the untested gas cylinder 3 is served to receive untested gases, each of the inert gas cylinder 1, the standard gas cylinder 2, and the untested gas cylinder 3 has an outlet pipe connecting with the first connecting tube 5, and the outlet pipe has an exit 8. The each of the inert gas cylinder 1, the standard gas cylinder 2, and the untested gas cylinder 3 connects with the first connecting tube 5 via a high-pressure coil tube 14, a fourth control valve 15, and a high-pressure reducer 16, wherein the high-pressure reducer 16 communicates with the exit 8 through a fifth control valve 17.

The first connecting pipe 5 couples with the separating unit 4, and the separating unit 4 includes a controlling channel 42 and a separation chamber 44. The control channel 42 has a first control vale 11, a second control valve 12, and a third control valve 13, wherein an inlet end of the first control valve 11 connects with the first connecting pipe 5, and an inlet end of the second control valve 12 couples with the first connecting pipe 5, an outlet end of the second control valve 12 is in connection with the interface unit 7, and an outlet end of the third control valve 13 connects with the interface unit 7. The first control valve 11 is fixed between the first connecting pipe 5 and the separation chamber 44, the second control valve 12 is mounted between the first connecting pipe 5 and the interface unit 7, and the third control valve 13 is mounted between the separation chamber 44 and the interface unit 7. The separation chamber is covered in the cooling unit 6 and is comprised of a plurality of coil tubes.

The cooling unit 6 includes liquid nitrogen for serving as a coolant, and the liquid nitrogen is made from isopentane, for example, adding 200 ml of isopentane into the liquid nitrogen, and a digital display thermometer is placed in the cooling unit 6 so as to monitor a temperature in the cooling unit 6. The interface unit 7 also includes a glass rotameter 18 and the exit 8. It is to be noted that a plurality of exits 8 are fixed on a front end and a distal end of a pipeline so as to guide the mixed gases to flow toward outdoors, thus preventing worker from being damaged by flammable, explosive, toxic, chemically active electronic industrial gas.

The gas detection pre-treatment device is produced at low cost and is used easily.

A method of testing gases of the gas detection pre-treatment device of the present invention is applied to analyze chromatogram of the mixed gases, and the mixed gases is comprised of electronic industrial gas, such as Silane (SiH4) or Germane (GeH₄). Because a difference exists among a boiling point (i.e., −111.8° C.) of SiH₄, a boiling point (i.e., −190° C.) of GeH₄, and a boiling point of impurities of (SiH4) or Germane (GeH₄), low boiling points of the impurities are set, for example, a low boiling point of H₂ is set at −252.80° C., a low boiling point of N₂ is set at −195.80° C., a lower boiling point of CO is set at −191.40° C., and a low boiling point of CH₄ is set at −161.5° C. In addition, high boiling points of the impurities are set as well, for instance, a high boiling point of Oxide is set at −88.63° C., a high boiling point of CO₂ is set at −78.48° C., and a high boiling point of Propane is set at −42.07° C. Fraction, which has a boiling point lower than SiH4 and GeH4, is acquired by ways of low-temperature fractionation so as to separate the mixed gases into two separated gases, wherein one of the two separated gases without main compositions is guided into a gas chromatograph to be analyzed further.

Accordingly, steps of analyzing separated gas without main compositions include:

(1) holding the inert gas, the standard gas, and the untested gas into the inert gas cylinder 1, the standard gas cylinder 2, and the untested gas cylinder 3;

(2) blowing the inert gas in the inert gas cylinder 1 toward the pipeline;

(3) blowing the standard gas in the standard gas cylinder 2 toward the pipeline, turning off the first control valve 11 and the third control valve 13, sealing and cooling the standard gas in the separation chamber 44 at a certain amount within a period of time so as to separate the standard gas, i.e., an inflow amount of the standard gas is controlled by the glass rotameter 18, wherein a flowing speed of the standard gas is controlled within 60 to 100 ml/min, and then the first control valve 11 and the third control valve 13 are turned off after blowing the standard gas, such that the standard gas in a certain amount is sealed in the separation 44 and is cooled for twenty minutes at −150° C., thus separating a part of gas from the standard gas;

(4) blowing a part of separated standard gas into the interface unit 7 by means of the inert gas in the inert gas cylinder 1 so as to analyze the part of separated standard gas by using the gas chromatograph, wherein a flowing speed of the inert gas is controlled within 60 to 100 ml/min;

(5) blowing the inert gas in the inert gas cylinder 1 toward the pipeline;

(6) blowing the untested gas in the untested gas cylinder 3 toward the pipeline, turning off the first control valve 11 and the third control valve 13, sealing and cooling the untested gas in the separation chamber 44 at a certain amount within a period of time so as to separate the untested gas, i.e., an inflow amount of the untested gas is controlled by the glass rotameter 18, wherein a flowing speed of the untested gas is controlled within 60 to 100 ml/min, and then the first control valve 11 and the third control valve 13 are turned off after blowing the untested gas, such that the untested gas in a certain amount is sealed in the separation 44 and is cooled for twenty minutes at −150° C., thus separating a part of gas from the untested gas;

(7) blowing a part of separated untested gas into the interface unit 7 by means of the inert gas in the inert gas cylinder 1 so as to analyze the part of separated untested gas by ways of the gas chromatograph, wherein a flowing speed of the inert gas is controlled within 60 to 100 ml/min;

(8) marking content of impurities of the mixed gas by using the standard gas.

In addition, 200 ml of liquid nitrogen made from isopentane is fed into the cooling unit 6 in advance so as to control the temperature of the cooling unit 6 at −150° C.

After above-mentioned step, a temperature of the high-pressure coil tube is raised so that gas residue in the high-pressure coil tube is volatilized and is blew by inert gas, then step (6) is repeated so as to test untested mixed gases repeatedly.

After step (4), a standard gas sample is parallelly tested at least twice, and then a chromatographic response value is recorded until relative deviation of two continuous tests is less than 5%, and then two test values of the two continuous tests are averaged. Also, after step (7), relative deviation of two continuous tests is less than 5%, and then two test values of the two continuous tests are averaged.

In above-mentioned step, a gas pipeline outside the cooling unit 6 has a certain length, so to avoid residual gas influencing the gas pipeline, and the gas pipeline outside the cooling unit 6 is below by inert gas before a chromatographic analysis.

Thereby, the cryogenic distillation technology is applied in a pre-test process for a purity test of flammable, explosive, toxic, industrial gas so as to prevent flammable, explosive, and toxic gases (such as SiH4, GeH4) from polluting and damaging the gas chromatograph. In addition, dangerous main compositions in the electronic industrial gases are filtered, and chromatogram of impurities of the electronic industrial gases are analyzed so as to test purity of flammable, explosive and toxic electronics industrial gases quickly and safely at low cost.

Furthermore, the gas detection pre-treatment device is used to cryogenically distill mixed gas, and main compositions of the mixed gases with a high boiling point (such as SiH4, GeH4) are filtered so that the main compositions of the mixed gases with the high boiling point do not flow into the gas chromatograph, thus preventing the gas chromatograph from being polluted. Besides, toxic gas is discharged out of the plurality of exits 8 of the front end and the distal end of the pipeline, thus preventing worker from being damaged by flammable, explosive, toxic, chemically active electronic industrial gas. Also, the SiH4 and/or GeH4 is filtered by the gas detection pre-treatment device so that back flushing path is omitted to lower production costs of the gas chromatograph and the gas detection pre-treatment device.

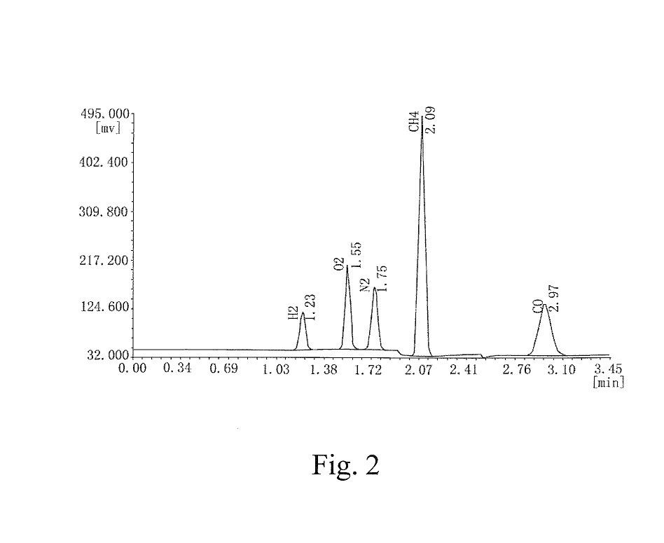

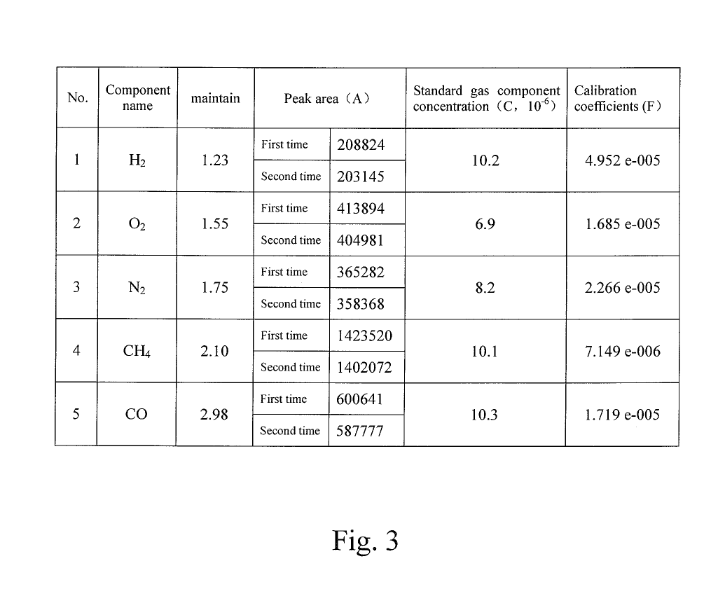

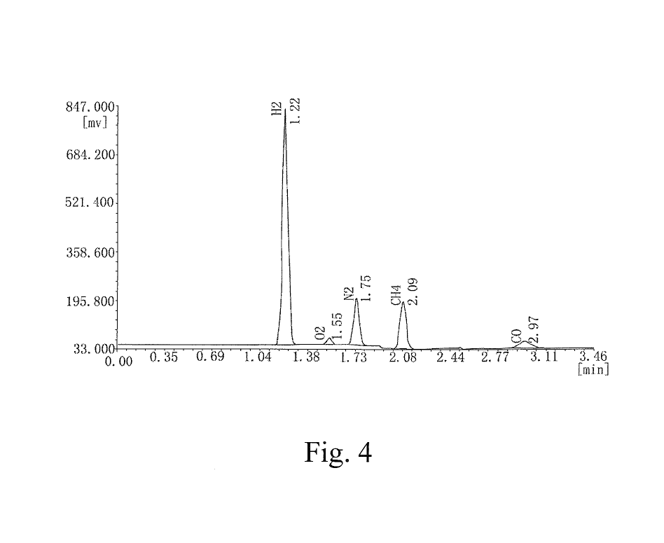

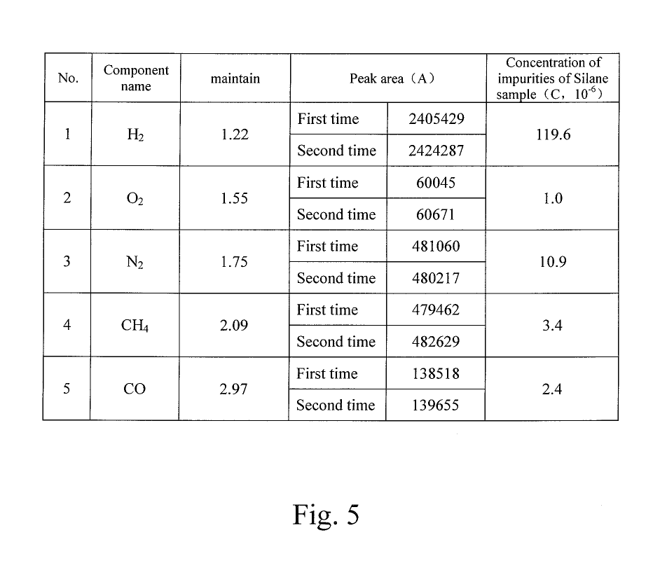

A test report of conventional gas chromatograph having the back flushing path is shown in FIGS. 2-5, wherein a gap chromatograph mode is a Huaai HG-9560, a chromatogram column is a 5A molecular sieve, and a detector is a pulse helium ionization detector (PDHID), wherein a back flushing is processed in 3.2 minutes so that main compositions of the mixed gases, i.e., Silane, are blew toward outdoor and then exhaust is absorbed.

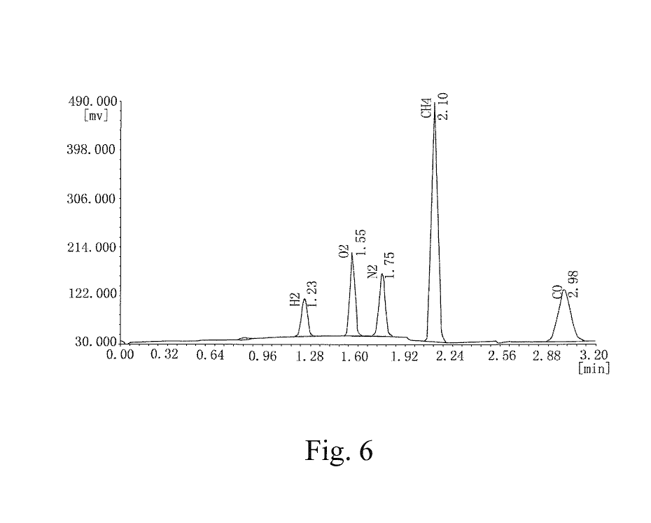

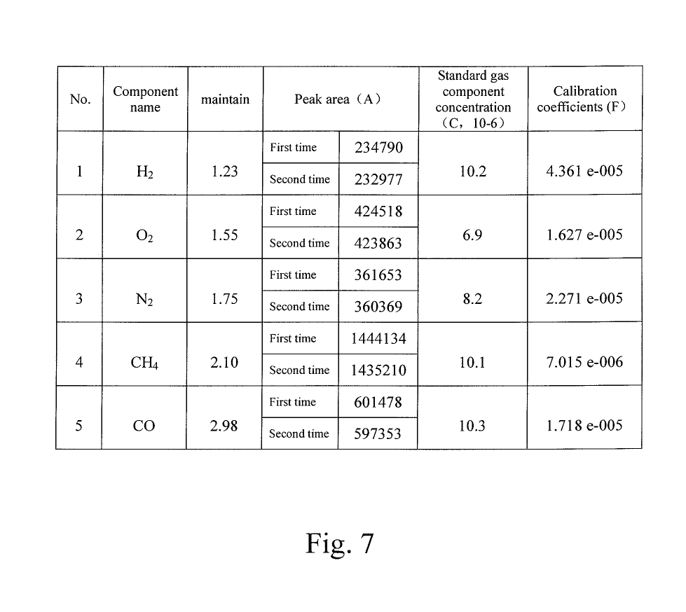

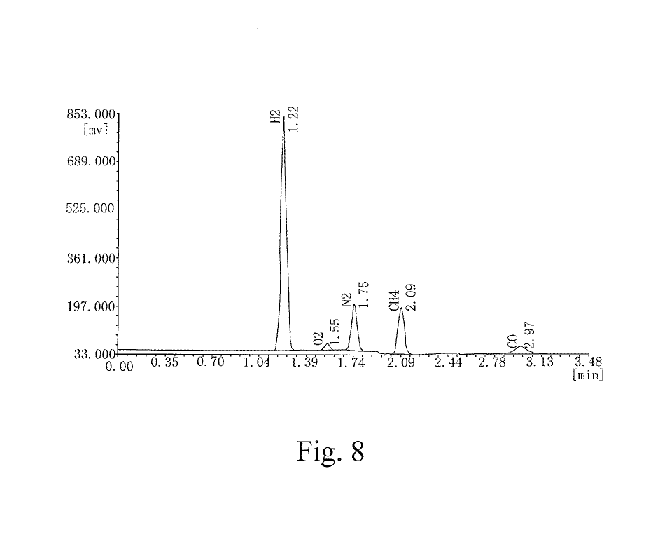

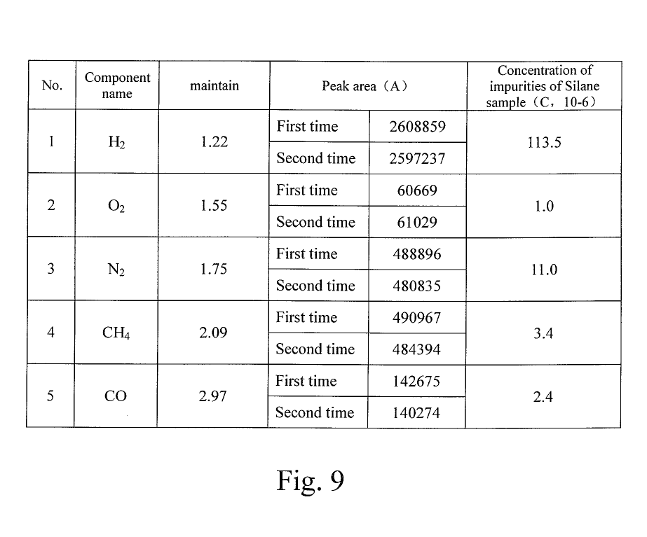

A test report of the gas chromatograph of the present invention having the back flushing path is shown in FIGS. 6-9, wherein a gap chromatograph mode is a Huaai HG-9560, a chromatogram column is a 5A molecular sieve, and a detector is a pulse helium ionization detector (PDHID), wherein a back flushing does not process in 3.2 minutes, and a gas sample comprised of Silane is separated from impurities by gas purification pretreatment device, and then the impurities are tested by the detector.

Referring further to FIGS. 2-9, a Silane sample is tested by using the method of testing gases of the gas detection pre-treatment device of the present invention and a conventional gas chromatography method, thereafter an test error of a test result of the method of testing gases of the present invention is less than 5% compared with conventional gas chromatography method, so the test result of the method of testing gases of the present invention is accurate.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A gas detection pre-treatment device being used to analyze chromatogram of mixed gases and comprising an inert gas cylinder, a standard gas cylinder, an untested gas cylinder, a separating unit, a first connecting tube, a cooling unit, and an interface unit;
wherein each of the inert gas cylinder, the standard gas cylinder, and the untested gas cylinder has an outlet pipe connecting with the first connecting tube, the first connecting pipe couples with the separating unit, and the separating unit includes a controlling channel and a separation chamber, the control channel has a first control vale, a second control valve, and a third control valve, wherein an inlet end of the first control valve connects with the first connecting pipe, and an inlet end of the second control valve couples with the first connecting pipe, an outlet end of the second control valve is in connection with the interface unit, and an outlet end of the third control valve connects with the interface unit, the first control valve is fixed between the first connecting pipe and the separation chamber, the second control valve is mounted between the first connecting pipe and the interface unit, and the third control valve is mounted between the separation chamber and the interface unit, the separation chamber is covered in the cooling unit.

2. The gas detection pre-treatment device as claimed in claim 1, wherein in that the interface unit includes a glass rotameter and an exit.

3. The gas detection pre-treatment device as claimed in claim 1, wherein the outlet pipe has the exit.

4. The gas detection pre-treatment device as claimed in claim 3, wherein the each of the inert gas cylinder, the standard gas cylinder, and the untested gas cylinder connects with the first connecting tube via a high-pressure coil tube, a fourth control valve, and a high-pressure reducer, wherein the high-pressure reducer communicates with the exit through a fifth control valve.

5. The gas detection pre-treatment device as claimed in claim 1, wherein the cooling unit includes liquid nitrogen, and the cooling unit is comprised of a plurality of coil tubes.

6. A method of testing gases of a gas detection pre-treatment device comprising:
(1) holding inert gas, standard gas, and untested gas into inert a gas cylinder, a standard gas cylinder, and a untested gas cylinder;
(2) blowing the inert gas in the inert gas cylinder toward a pipeline;
(3) blowing the standard gas in the standard gas cylinder toward the pipeline, turning off a first control valve and a third control valve, sealing and cooling the standard gas in the separation chamber at a certain amount within a period of time so as to separate the standard gas;
(4) blowing a part of separated standard gas into an interface unit by means of the inert gas in the inert gas cylinder so as to analyze the part of separated standard gas by using the gas chromatograph;
(5) blowing the inert gas in the inert gas cylinder toward the pipeline;
(6) blowing the untested gas in the untested gas cylinder toward the pipeline, turning off the first control valve and the third control valve, sealing and cooling the untested gas in the separation chamber at a certain amount within a period of time so as to separate the untested gas;
(7) blowing a part of separated untested gas into the interface unit by means of the inert gas in the inert gas cylinder so as to analyze the part of separated untested gas by ways of the gas chromatograph;
(8) marking content of impurities of the mixed gas by using the standard gas.

7. The method of testing gases of the gas detection pre-treatment device as claimed in claim 6, wherein the mixed gases are Silane or germane.

8. The method of testing gases of the gas detection pre-treatment device as claimed in claim 6, wherein a flowing speed of the inert gas of step (4) is controlled within 60 to 100 ml/min, a flowing speed of the inert gas of step (7) is controlled within 60 to 100 ml/min, and a temperature of a cooling unit is at −150° C.

9. The method of testing gases as claimed in claim 8, wherein the cooling unit includes liquid nitrogen for serving as a coolant, and the liquid nitrogen is made from isopentane so as to monitor a temperature in the cooling unit.

10. A method of testing gases comprising:
separating gas into a first part and a second part by using cryogenic distillation, wherein a boiling point of the second part is less than a boiling point of the first part; and the second part is guided into gas chromatograph to be analyzed by using inert gas.
